(19) United States
(12) Patent Application Publication
(10) Pub. No.: US 2015/0269162 A1
(43) Pub. Date: Sep. 24, 2015

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Kouta Nakata, Tokyo (JP); Masahide Ariu, Yokohama (JP)

(21) Appl. No.: 14/644,395

(22) Filed: Mar. 11, 2015

(30) Foreign Application Priority Data
Mar. 20, 2014 (JP) 2014-058246

(51) Int. Cl. G06F 17/30

(52) U.S. Cl. CPC G06F 17/3053; G06F 17/30011

(57) ABSTRACT

According to an embodiment, an information processing device includes a first feature calculator, a second feature calculator, a similarity calculator, and a selector. The first feature calculator is configured to calculate a topic feature representing a strength of relevance of document of at least one topic to a target document that matches a purpose for which a language model is to be used. The second feature calculator is configured to calculate the topic feature for each of a plurality of candidate documents. The similarity calculator is configured to calculate a similarity of each of the topic features of the candidate documents to the topic feature of the target document. The selector is configured to select, as a document to be used for learning the language model, a candidate document whose similarity is larger than a reference value from among the candidate documents.

### CROSS-REFERENCE TO RELATED APPLICATION

This application is based upon and claims the benefit of priority from Japanese Patent Application No. 2014-058246, filed on Mar. 20, 2014; the entire contents of which are incorporated herein by reference.

### FIELD

Embodiments described herein relate generally to an information processing device, an information processing method, and a computer program product therefor.

### BACKGROUND

Through the spread of computers and Internet environment, large quantities of documents have been computerized and stored. It is possible to learn language models used in technologies such as speech recognition by using such large quantities of computerized documents. Learning of a language model used for a general purpose by using large quantities of documents available on the web, for example, can improve the performance of the language model. In contrast, learning of a language model used for a specific purpose by using large quantities of documents available on the web will not improve the performance significantly because a large number of documents relating to purposes other than the specific purpose are included.

To improve the performance of a language model used for a specific purpose, it is necessary to learn the language model by using only documents (target documents) relating to the specific purpose. When the specific purpose is speech recognition at a call center, for example, the performance of the language model used for this specific purpose can be improved by using documents obtained by transcribing speech of conversation of operators at the call center to learn the language model.

With such a method, however, a language model for diverse expressions cannot be achieved when sufficient quantities of target documents are not used for learning. It is, however, difficult to collect a large number of documents relating to a specific purpose. The work of transcribing speech into documents, for example, requires large economical and time costs, so it is difficult to obtain sufficient quantities of target documents.

### BRIEF DESCRIPTION OF THE DRAWINGS

FIG. 1 is a diagram illustrating a configuration of an information processing device according to a first embodiment;

FIG. 2 is a table illustrating an example of topic information in which the number of topics is 50;

FIG. 3 is a chart illustrating a processing flow of the information processing device according to the first embodiment;

FIG. 4 is a diagram illustrating a first example of a target document;

FIG. 5 is a diagram illustrating a first example of candidate documents;

FIG. 6 is a diagram illustrating a second example of the candidate documents;

FIG. 7 is a diagram illustrating a third example of the candidate documents;

FIG. 8 is a chart illustrating a topic feature calculation flow;

FIG. 9 is a diagram illustrating an example of a document with a high degree of coincidence of words;

FIG. 10 is a table illustrating an example of topic information in which the number of topics is 10;

FIG. 11 is a table illustrating an example of topic information in which the number of topics is 200;

FIG. 12 is a chart illustrating a processing flow for selecting topic information;

FIG. 13 is a table illustrating an example of topic information according to a second modified example;

FIG. 14 is a diagram illustrating a configuration of an information processing device according to a second embodiment;

FIG. 15 is a chart illustrating a processing flow of the information processing device according to the second embodiment;

FIG. 16 is a diagram illustrating a second example of a target document;

FIG. 17 is a diagram illustrating an example of a similar target document;

FIG. 18 is a table illustrating an example of topic information on a first part-of-speech group;

FIG. 19 is a table illustrating an example of topic information on a second part-of-speech group; and

FIG. 20 is a diagram illustrating a hardware configuration of an information processing device.

### DETAILED DESCRIPTION

According to an embodiment, an information processing device includes a first feature calculator, a second feature calculator, a similarity calculator, and a selector. The first feature calculator is configured to calculate a topic feature representing a strength of relevance of document of at least one topic to a target document that matches a purpose for which a language model is to be used. The second feature calculator is configured to calculate the topic feature for each of a plurality of candidate documents. The similarity calculator is configured to calculate a similarity of each of the topic features of the candidate documents to the topic feature of the target document. The selector is configured to select, as a document to be used for learning the language model, a candidate document whose similarity is larger than a reference value from among the candidate documents.

### First Embodiment

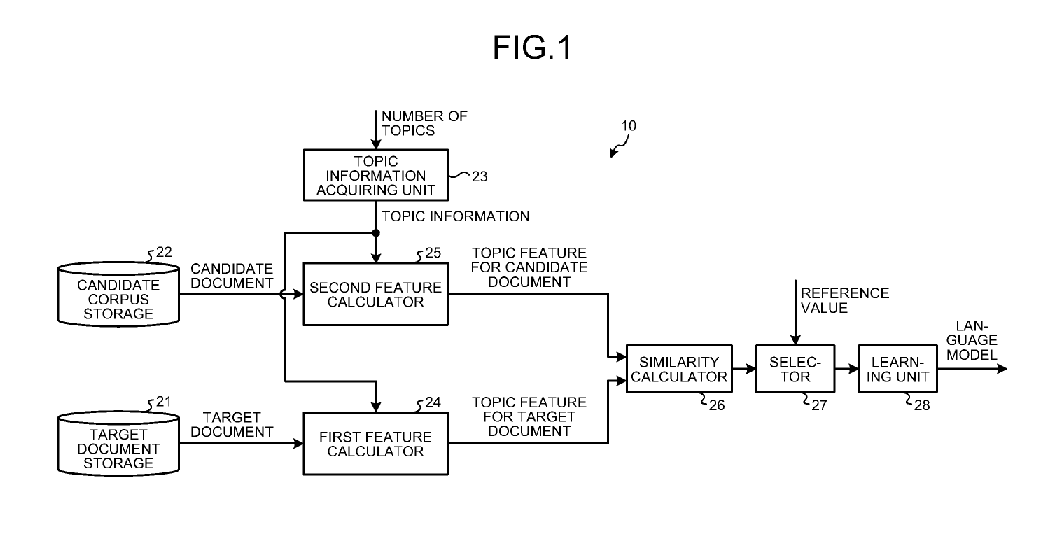

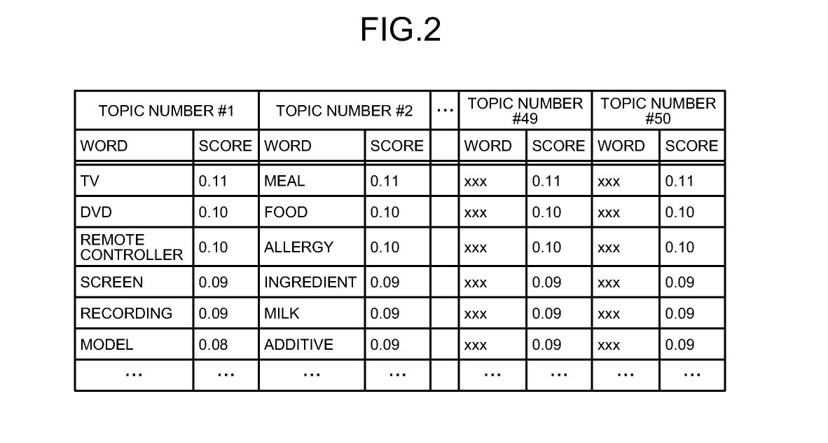

FIG. 1 is a diagram illustrating a configuration of an information processing device 10 according to a first embodiment. FIG. 2 is a table illustrating an example of topic information in which the number of topics is 50.

The information processing device 10 selects documents to be used for learning a language model from multiple candidate documents on the web or the like, and learns the language model using the selected candidate documents. The information processing device 10 includes a target document storage 21, a candidate corpus storage 22, a topic information acquiring unit 23, a first feature calculator 24, a second feature calculator 25, a similarity calculator 26, a selector 27, and a learning unit 28.

The target document storage 21 stores documents (target documents) matching the purpose for which the language model to be learned is to be used. The target documents are selected manually by a user, for example. When a language model to be learned is to be used for speech recognition at a call center, the target documents are texts into which speech of operators at the call center is transcribed, for example.

The candidate corpus storage 22 stores multiple documents (candidate documents) that are candidates of documents to be used for learning a language model. The candidate documents are large quantities of texts collected from the web, for example. The candidate documents include documents used for various purposes such as articles in news sites and comments posted on message boards, for example, and also include documents used for purposes other than that for which the language model is to be used. The candidate corpus storage 22 may be provided in a server on a network or may be distributed in multiple servers instead of being provided in the information processing device 10.

The topic information acquiring unit 23 acquires topic information. The topic information contains a set of pairs of words and scores for each topic as illustrated in FIG. 2.

A topic refers to a central subject (theme) of a document and features of the document such as the style of speech. One document may contain multiple topics. The topic number #1 in FIG. 2, for example, represents a topic of digital home electric appliances. The topic number #2 in FIG. 2 represents a topic relating to food. The topic information may further include a topic representing a polite speech style and a topic representing a written language style (a style used in writing).

Words belonging to each topic in the topic information are words relating to the topic and may be contained in a document relating to the topic. Each of the words contained in the topic information is paired with a score. A score represents the strength of relevance to the topic to which the word belongs. In the present embodiment, a score is higher as the relevance to the associated topic is stronger.

In the topic information, one word may belong to multiple topics. Furthermore, any number of topics may be contained in the topic information.

The topic information is generated by setting multiple topics by a user and collecting words relating to the respective topics by the user, for example. For another example, the topic information is generated by setting multiple topics by a user, providing documents relating to each topic by the user, and calculating the frequencies of words in the provided documents by a computer, for example.

Alternatively, the topic information acquiring unit 23 may automatically generate the topic information using such an unsupervised topic analysis technology as disclosed in the following reference:
Blei, David M., Andrew Y. Ng, and Michael I. Jordan. “Latent dirichlet allocation.” the Journal of machine Learning research 3 (2003): P. 993-1022.

In this method, a user first sets the number N of topics. The topic information acquiring unit 23 then analyzes large quantities of diverse documents to generate topic information classified into N topics. According to this method, the topic information acquiring unit 23 can generate the topic information without using previous knowledge of the topics.

The first feature calculator 24 calculates a topic feature for a target document stored in the target document storage 21 on the basis of the topic information. A topic feature represents the strengths of relevance of the document to the respective topics. In the present embodiment, a topic feature is expressed by a vector (array) as the following Equation (1).

\vec{T}(t)=(T₁,T₂, . . . , T₄₉,T₅₀)=(0.74,0.03, . . . , 0.06,0.65) (1)

A topic feature expressed by a vector contains elements (T₁, T₂, . . . , T₄₉, T₅₀, for example), the number of the elements corresponding to the number of topics contained in the topic information. Each of the elements contained in a topic feature is associated one-to-one with a topic contained in the topic information. Each element represents the strength of relevance of the document to the associated topic. The element T₁ in Equation (1), for example, represents the strength of relevance of the document to the topic of the topic number #1 in the topic information illustrated in FIG. 2.

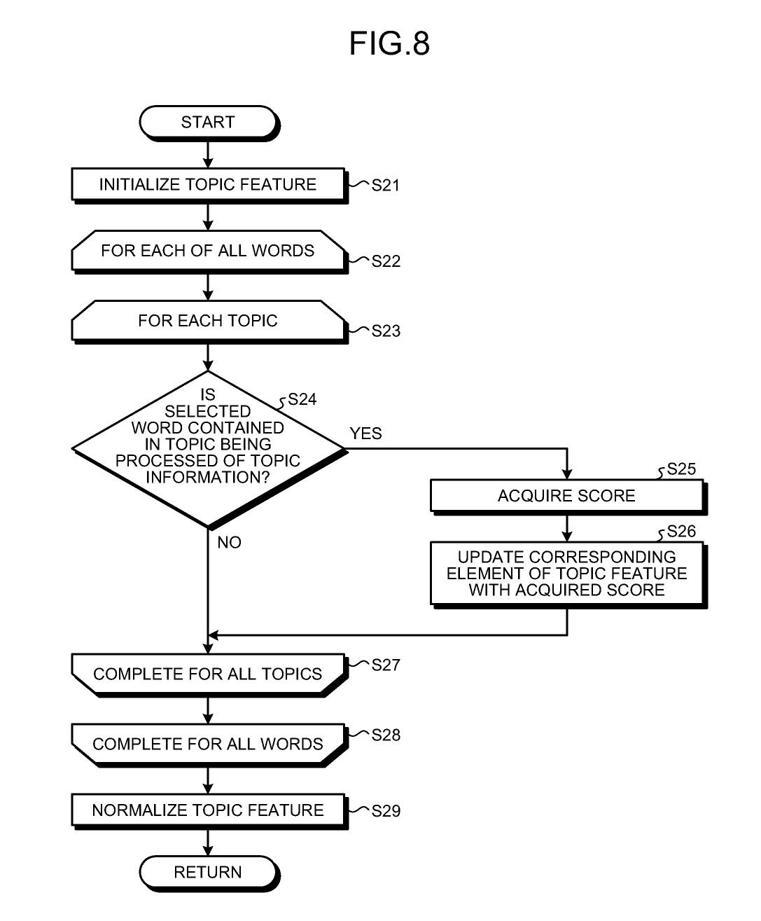

Such a topic feature represents the distribution of the strengths of relevance of the document to the respective topics. A more detailed method for calculating a topic feature will be described later with reference to FIG. 8.

The second feature calculator 25 calculates a topic feature for each candidate document stored in the candidate corpus storage 22 on the basis of the topic information. A topic feature for a candidate document is in the same form as that of a topic feature for a target document, and is calculated by the same calculation method.

The similarity calculator 26 calculates the similarity of each of topic features for multiple candidate documents to the topic feature for the target document. Specifically, the similarity calculator 26 calculates how similar to the distribution of the strengths of relevance of the respective topics in the target document the distribution of the strengths of relevance of the respective topics in each of candidate documents is.

In the present embodiment, the similarity calculator 26 calculates the similarity by computing an inner product of topic features expressed by vectors. Specifically, the similarity calculator 26 multiplies each of the elements contained in the topic feature for a candidate document by a corresponding element in the topic feature for the target document, and calculates a sum of all of the multiplication results as the similarity.

The selector 27 selects candidate documents whose similarities are larger than a reference value as documents to be used for learning a language model from multiple candidate documents. Note that the reference value may be a value set by the user. Alternatively, the reference value may be a value calculated on the basis of similarities of multiple candidate documents. The reference value may be a value that is smaller by a certain amount than the average value of the similarities of multiple candidate documents or the maximum value of the similarities of multiple candidate documents, for example.

The learning unit 28 learns a language model on the basis of the candidate documents selected by the selector 27. The learning unit 28 learns an n-gram language model by using a common known technique, for example.

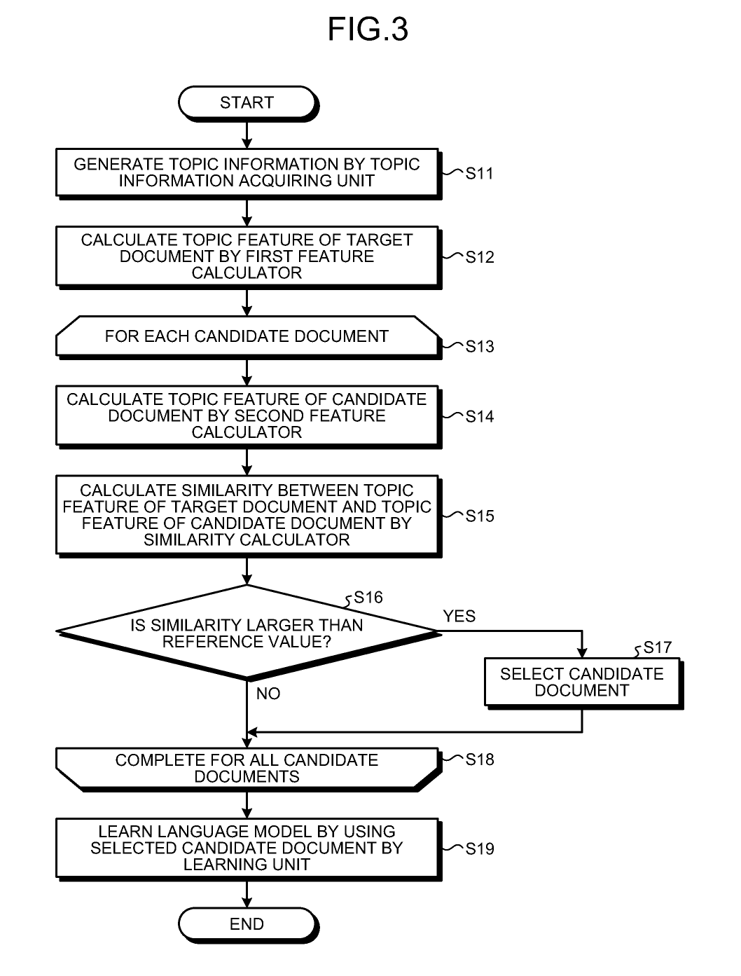

FIG. 3 is a chart illustrating a processing flow of the information processing device 10 according to the first embodiment. In the present flow, an example in which a language model to be used for speech recognition at a call center of home electric appliance manufacturer will be described. Furthermore, in the present flow, an example in which the topic information illustrated in FIG. 2 is used will be described.

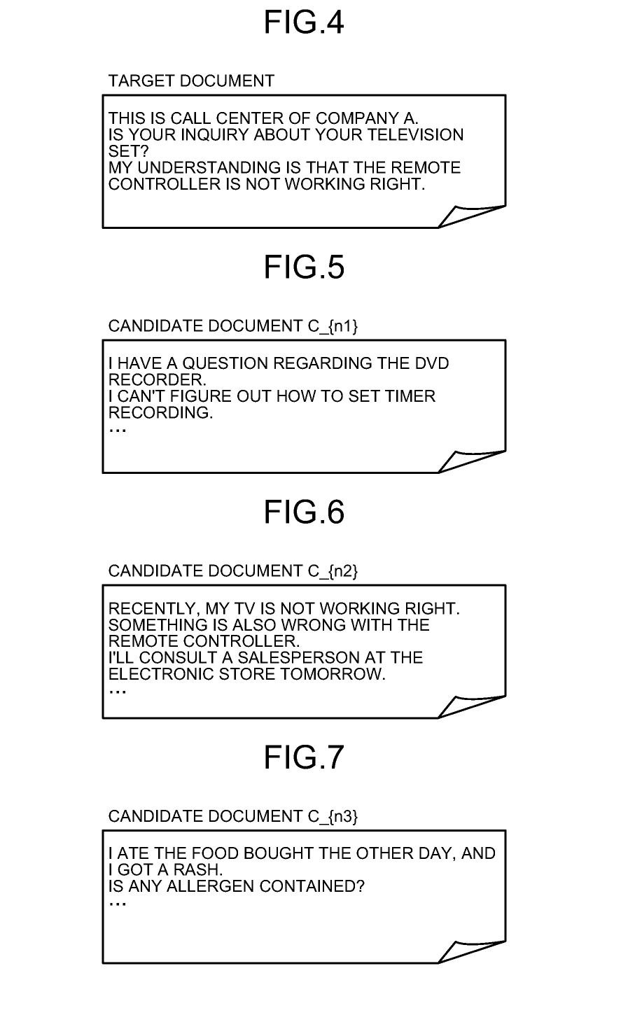

Before the processing, target documents are stored in the target document storage 21 by the user in advance. The target document storage 21 stores texts into which speech responding to inquiries about remote controllers for television sets (also referred to as TVs) as illustrated in FIG. 4 is transcribed, for example, as the target documents.

Furthermore, before the processing, the information processing device 10 acquires multiple candidate documents from the web or the like and stores the acquired candidate documents in the candidate corpus storage 22. The candidate corpus storage 22 stores candidate documents as those illustrated in FIGS. 5, 6, and 7, for example. The candidate document C_{n1} illustrated in FIG. 5 is a text into which speech of an inquiry about a DVD recorder to a call center of a home electric appliance manufacturer is transcribed. The candidate document C_{n2} illustrated in FIG. 6 is a text written on the web and stating that a TV is not working right. The candidate document C_{n3} illustrated in FIG. 7 is a text into which speech of an inquiry about an allergen to a call center of a food manufacturer is transcribed.

First, in step S11, the topic information acquiring unit 23 generates topic information. The topic information acquiring unit 23 may acquire topic information saved beforehand.

Subsequently, in step S12, the first feature calculator 24 accumulates scores of words contained in a target document for each topic to calculate a topic feature of the target document. Specifically, the first feature calculator 24 calculates the topic feature of the target document through procedures illustrated in steps S21 to S29 in FIG. 8.

In step S21 of FIG. 8, the first feature calculator 24 initializes the topic feature. In the present example, all elements contained in the topic feature are initialized to 0.0 as expressed by the following Equation (2).

\vec{T}(t)=(T₁,T₂, . . . , T₄₉,T₅₀)=(0.0,0.0, . . . , 0.0,0.0) (2)

Subsequently, the first feature calculator 24 repeats processing from step S23 to step S27 for each of all words contained in the document being processed (loop processing between step S22 and step S28). The first feature calculator 24 selects one word sequentially from the first word to the last word in the document being processed and performs the processing from step S23 to step S27 thereon, for example.

In the loop processing for each word, the first feature calculator 24 further repeats processing from step S24 to step S26 for each topic indicated in the topic information (loop processing between step S23 and step S27). The first feature calculator 24 selects a topic sequentially from the topic number #1 to the topic number #50 of the topic information and performs the processing from step S24 to step S26 thereon, for example.

In the loop processing for each topic, first, in step S24, the first feature calculator 24 determines whether or not the selected word is contained in a set of words of the topic being processed in the topic information. If the word is not contained (No in step S24), the first feature calculator 24 moves the processing to step S27. If the word is contained (Yes in step S24), the first feature calculator 24 moves the processing to step S25.

In step S25, the first feature calculator 24 acquires a score associated with (to be paired with) the selected word from the set of words of the topic being processed in the topic information. Subsequently, in step S26, the first feature calculator 24 updates a corresponding element of the topic feature with the acquired score. The first feature calculator 24 adds the acquired score to the corresponding element of the topic feature, for example.

Assume that the word being processed in the loop processing is “TV” and that the topic being processed in the loop processing is the topic number #1, for example. In this case, “TV” in the set of words of the topic number #1 is present. The first feature calculator 24 thus adds the score (0.11) associated with “TV” of the topic number #1 to the first element T₁ of the topic feature. The following Equation (3) expresses the topic feature resulting from the addition of the score (0.11) associated with “TV” to the initialized topic feature.

\vec{T}(t)=(T₁,T₂, . . . ,T₄₉,T₅₀)=(0.11,0.0, . . . , 0.0,0.0) (3)

After the processing in step S26 is completed, the first feature calculator 24 moves the processing to step S27. In step S27, if the processing from step S24 to step S26 has not yet been completed for all the topics, the first feature calculator 24 returns the processing to step S23 and repeats the processing for the next topic. If the processing is completed, the first feature calculator 24 moves the processing to step S28.

In step S28, if the processing from step S23 to step S27 has not yet been completed for all the words, the first feature calculator 24 returns the processing to step S22 and repeats the processing for the next word. If the processing is completed, the first feature calculator 24 moves the processing to step S29.

The following Equation (4) expresses the topic feature after the updating process is completed for all the words. In the present example, since many words belonging to the topic number #1 are contained in the target document, the value of T₁ is larger than those of the other elements.

\vec{T}(t)=(T₁,T₂, . . . , T₄₉,T₅₀)=(2.5,0.1, . . . , 0.2,2.2) (4)

In step S29, the first feature calculator 24 normalizes the topic feature. In the present example, the topic feature is normalized by calculation expressed by the following Equation (5). Specifically, the first feature calculator 24 normalizes the topic feature by dividing each element Tᵢ by the mean square of all the elements.

$${T}_{i} = \frac{{T}_{i}}{\sqrt{{\sum }_{i = 1}^{50} {T}_{i}^{2}}} \qquad ( 5 )$$

The following Equation (6) expresses the topic feature resulting from normalization of the target document.

\vec{T}(t)=(T₁,T₂, . . . , T₄₉,T₅₀)=(0.74,0.03, . . . , 0.06,0.65) (6)

In the present example, in the topic feature resulting from normalization, the sum of squares of the elements is 1. As a result of normalization in this manner, the topic feature can indicate to which topic the document being processed is strongly relevant. Note that elements T₃ to T₄₈ are 0.0 in the topic feature of Equation (6). Thus, in the present embodiment, the target document is strongly relevant to the topics of the topic number #1 and the topic number #50.

The first feature calculator 24 calculates the topic feature for the target document as described above.

The description refers back to FIG. 3. Subsequently, the information processing device 10 repeats processing from step S14 to step S17 for each candidate document stored in the candidate corpus storage 22 (loop processing between step S13 and step S18).

In the loop processing for each candidate document, first in step S14, the second feature calculator 25 accumulates scores of words contained in the document being processed for each topic to calculate a topic feature of the candidate document. Specifically, the second feature calculator 25 calculates the topic feature for the candidate document through the procedures illustrated in steps S21 to S29 in FIG. 8.

The following Equations (7) express the topic features for the candidate document C_{n1}, the candidate document C_{n2}, and the candidate document C_{n3}.

\vec{T}(cₙ₁)=(0.70,0.01, . . . , 0.04,0.70)

\vec{T}(cₙ₂)=(0.71,0.02, . . . , 0.69,0.02)

\vec{T}(cₙ₃)=(0.01,0.68, . . . , 0.09,0.68) (7)

Note that elements T3 to T48 are 0.0 in the topic features expressed by Equations (7). The candidate document C_{n1} is strongly relevant to the topics of the topic number #1 and the topic number #50. The candidate document C_{n2} is strongly relevant to the topics of the topic number #1 and the topic number #49. The candidate document C_{n3} is strongly relevant to the topics of the topic number #2 and the topic number #50.

Subsequently, in step S15, the similarity calculator 26 calculates the similarity between the topic feature of the target document and the topic feature of the candidate document. In the present embodiment, the similarity calculator 26 calculates the inner product of the topic feature of the target document and the topic feature of the candidate document as expressed by the following Equation (8).

sim(t,cⱼ)=\vec{T}(t)·\vec{T}(cⱼ) (8)

The following Equations (9) express the similarity of the candidate document C_{n1}, the candidate document C_{n2}, and the candidate document C_{n3}.

$$\begin{matrix}sim ( t , {c}_{n 1} ) = 0.74 * 0.70 + 0.03 * 0.01 + 0.06 * 0.04 + 0.65 * 0.70 \\ = 0.98\end{matrix} \\ \begin{matrix}sim ( t , {c}_{n 2} ) = 0.74 * 0.71 + 0.03 * 0.02 + 0.06 * 0.69 + 0.65 * 0.02 \\ = 0.58\end{matrix} \\ \begin{matrix}sim ( t , {c}_{n 3} ) = 0.74 * 0.01 + 0.03 * 0.68 + 0.06 * 0.09 + 0.65 * 0.68 \\ = 0.48\end{matrix} \qquad ( 9 )$$

The similarity of the candidate document C_{n1} is 0.98. The similarity of the candidate document C_{n2} is 0.58. The similarity of the candidate document C_{n3} is 0.48. Since both of the target document and the candidate document C_{n1} are strongly relevant to the topics of the topic number #1 and the topic number #50, the similarity therebetween is higher than the other similarities.

Subsequently, in step S16, the selector 27 determines whether or not the similarity is larger than the reference value. If the similarity is not larger than the reference value (No in step S16), the selector 27 moves the processing to step S18. If the similarity is larger than the reference value (Yes in step S16), the selector 27 moves the processing to step S17.

In step S17, the selector 27 selects the corresponding candidate document as the document to be used for learning the language model. In the present example, the reference value is set to 0.70, and the selector 27 selects the candidate document C_{n1} whose similarity is larger than 0.70. The selector 27 then moves the processing to step S18.

In step S18, if the processing from step S14 to step S17 has not yet been completed for all the candidate documents, the selector 27 returns the processing to step S13 and repeats the processing for the next candidate document. If the processing is completed, the selector 27 moves the processing to step S19.

In step S19, the learning unit 28 learns the language model using the selected candidate document. After completing the processing in step S19, the information processing device 10 then terminates the present flow.

As described above, with the information processing device 10 according to the present embodiment, documents suitable for learning a language model can be efficiently selected from multiple candidate documents including large quantities of documents for other purposes. In particular, with the information processing device 10, a candidate document containing a relatively small number of words coincident with words contained in a target document can also be selected as a document to be used for learning a language model if the distribution of topics is similar.

When the target document illustrated in FIG. 4 and the candidate document C_{n1} illustrated in FIG. 5 are compared, for example, most of the contained words are different and the degree of coincidence on a word basis is thus low. “TV” in the target document illustrated in FIG. 4 and “DVD” in the candidate document C_{n1} illustrated in FIG. 5, however, are both recognized as words relating to digital home electric appliances and are thus determined to be similar according to the human sense. The information processing device 10 selects such a candidate document C_{n1}.

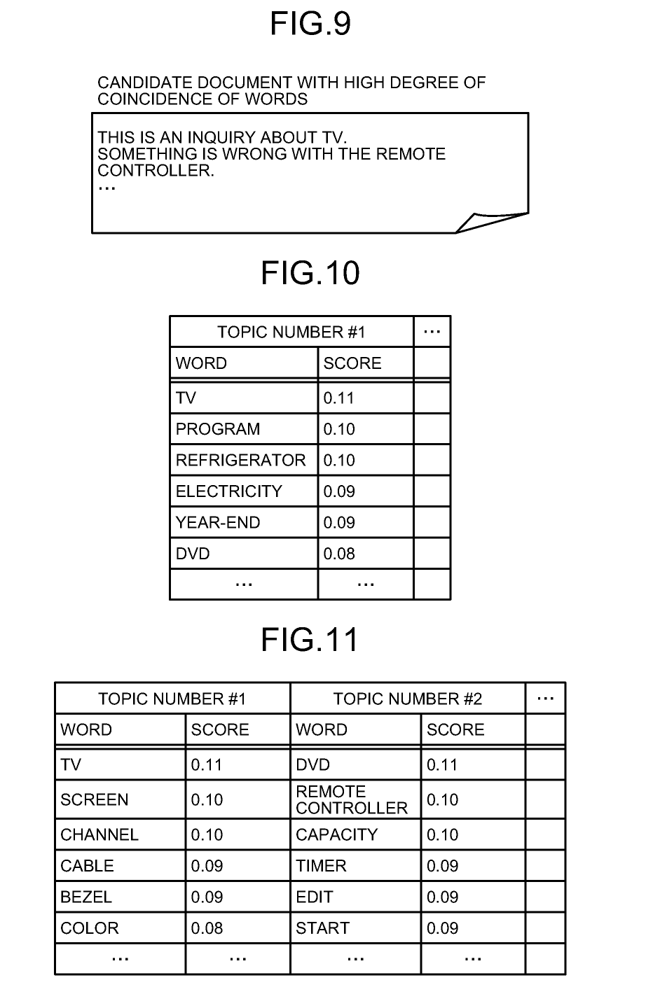

Furthermore, documents of a high degree of coincidence of words are likely to be composed of texts using substantially the same words. FIG. 9 is a diagram illustrating an example of a candidate document having a high degree of coincidence of words with the target document illustrated in FIG. 4. The candidate document of FIG. 9 is a document composed of expressions substantially the same as those of the target document. The language model learned by using such a candidate document as illustrated in FIG. 9 therefore becomes a language model that is weak in diverse expressions.

The information processing device 10 compares the topic features of the target document and the candidate document to determine the similarity. The information processing device 10 can therefore select a candidate document containing words belonging to the same topic even if the degree of coincidence of words with the target document is low. Since the elements of the topics of the topic number #1 and the topic number #50 are large in the candidate document C_{n1} illustrated in FIG. 5 similarly to the target document illustrated in FIG. 4, for example, the candidate document C_{n1} is selected as a document for learning the language model. The information processing device 10 can therefore appropriately select a candidate document determined to be similar to a target document according to the human sense. As a result, according to the information processing device 10, since a language model can be learned from documents containing diverse expressions relating to the purpose, a language model robust in diverse expressions can be generated.

### First Modified Example

Next, an information processing device 10 according to a first modified example of the first embodiment will be described.

FIG. 10 is a table illustrating an example of topic information in which the number of topics is 10. FIG. 11 is a table illustrating an example of topic information in which the number of topics is 200.

When the number of topics is small, words relating to a wide range are contained in one topic. As illustrated in FIG. 10, for example, in the topic information in which the number of topics is 10, words relating to television programs such as “program” and “year-end” in addition to words relating to digital home electric appliances such as “TV” and “DVD” are contained in the topic of the topic number #1.

When the number of topics is large, words relating to a narrow range are contained in one topic. As illustrated in FIG. 11, for example, in the topic information in which the number of topics is 200, “TV” and “DVD” belong separately to the topic of the topic number #1 and the topic number #2, respectively. The topic number #1 contains words relating to “TV” and the topic number #2 contains words relating to “DVD.”

The topic information acquiring unit 23 according to the first modified example therefore generates topic information for each of multiple numbers N of topics, and selects the most suitable topic information from the generated topic information.

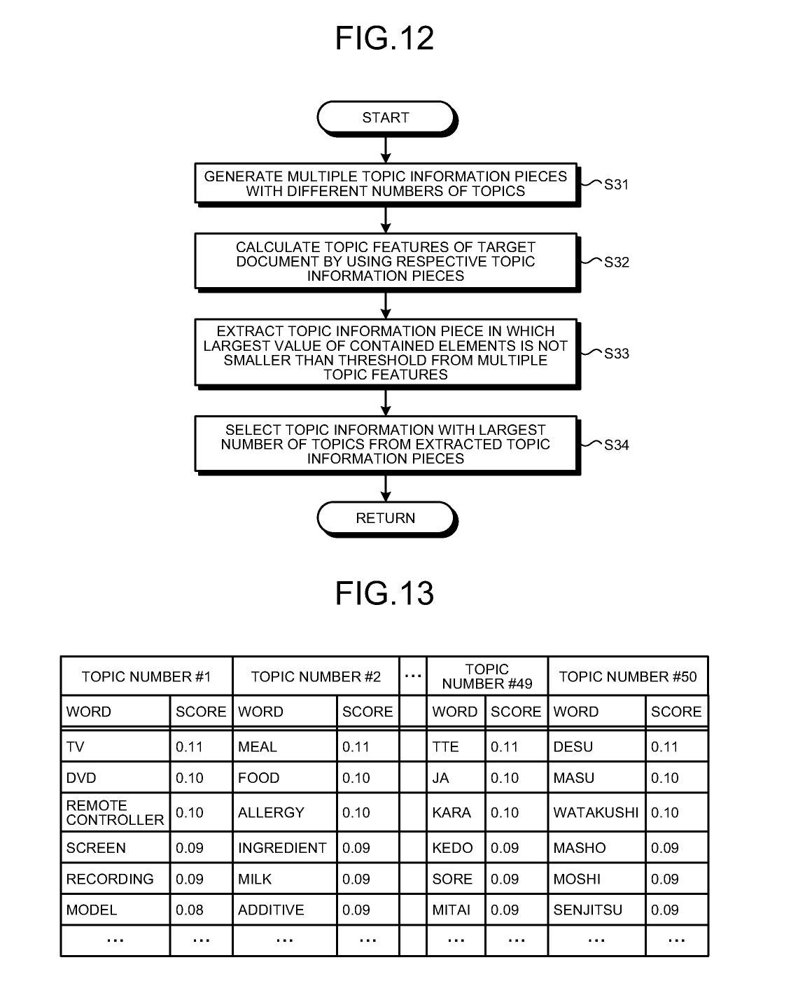

FIG. 12 is a chart illustrating a processing flow for selecting topic information containing a suitable number of topics.

First, in step S31, the topic information acquiring unit 23 generates a plurality of pieces of topic information containing different numbers of topics. In the present example, the topic information acquiring unit 23 generates a plurality of pieces of topic information in which the numbers N of topics are N=10, N=50, and N=200.

Subsequently, in step S32, the topic information acquiring unit 23 calculates the topic feature of the target document on the basis of each of the pieces of topic information containing different numbers of topics. The following Equations (10) express the pieces of topic information in which the numbers of topics are N=10, N=50, and N=200. Note that the element T₃ and the subsequent elements are 0.0 in the topic features expressed by Equations (10).

\vec{T}₁₀(t)=(T₁,T₂, . . . )=(0.80,0.04, . . . )

\vec{T}₅₀(t)=(T₁,T₂, . . . )=(0.74,0.03, . . . )

\vec{T}₂₀₀(t)=(T₁,T₂, . . . )=(0.54,0.50, . . . ) (10)

In the pieces of topic information in which the numbers of topics are N=10 and N=50, “TV” and “remote controller” belong to the topic of the topic number #1. Thus, in the topic features based on the pieces of topic information in which the numbers of topics are N=10 and N=50, the value of the element T₁ of the topic number #1 is large.

In the topic information piece in which the number of topics is N=200, “TV” belongs to the topic of the topic number #1 and “remote controller” belongs to the topic of the topic number #2. Thus, in the topic feature based on the topic information piece in which the number of topics is N=200, the element T₁ of the topic number #1 is substantially equal to the element T₂ of the topic number #2.

Subsequently, in step S33, the topic information acquiring unit 23 extracts a topic information piece in which the value of the largest value of the contained elements is not smaller than a threshold from the generated pieces of topic information. In the present example, the value of the largest element in the topic feature based on the topic information with the number of topics N=10 is 0.80. The value of the largest element in the topic feature based on the topic information with the number of topics N=50 is 0.74. Furthermore, the value of the largest element in the topic feature based on the topic information with the number of topics N=200 is 0.54. In a case where the threshold is 0.7, the topic information acquiring unit 23 extracts the topic information with the number of topics N=10 and the topic information with the number of topics N=50 as pieces of topic information not smaller than the threshold.

Subsequently, in step S34, the topic information acquiring unit 23 selects the topic information piece with the largest number of topics from the extracted pieces of topic information. In the present example, the topic information acquiring unit 23 selects the topic information with the number of topics N=50.

In this manner, the information processing device 10 according to the first modified example selects a candidate document for learning a language model by using topic information in which the number of topics is set to an appropriate number. As a result, according to the information processing device 10 according to the present modified example, a language model with better performance can be learned.

### Second Modified Example

Next, an information processing device 10 according to a second modified example of the first embodiment will be described. FIG. 13 is a table illustrating an example of topic information according to the second modified example.

The topic information according to the second modified example contains a set of words of topics expressing styles of sentences and speech. The topic of the topic number #49 in the topic information illustrated in FIG. 13, for example, contains a set of words used for a usual speech style used in conversation between close friends. The topic of the topic number #50 in the topic information illustrated in FIG. 13 contains a set of words used for a polite speech style used in customer services and the like.

Operators at call centers normally utter speech in a polite speech style. Thus, a language model used for recognition of speech of operators at call centers can be efficiently learned by selecting a document containing words belonging to digital home electric appliances and containing words used in a polite speech style such as “desu” and “masu” used at the ends of sentences in Japanese.

Thus, with the information processing device 10 according to the second modified example, since the topic information contains a set of words of a topic expressing a speech style, a more appropriate candidate document can be selected for learning a language model of a specific purpose.

### Second Embodiment

Next, an information processing device 10 according to a second embodiment will be described. The information processing device 10 according to the second embodiment has substantially the same functions and configuration as those of the information processing device 10 according to the first embodiment. Components having substantially the same functions and configuration will be designated by the same reference numerals and will thus not be described in detail except for differences.

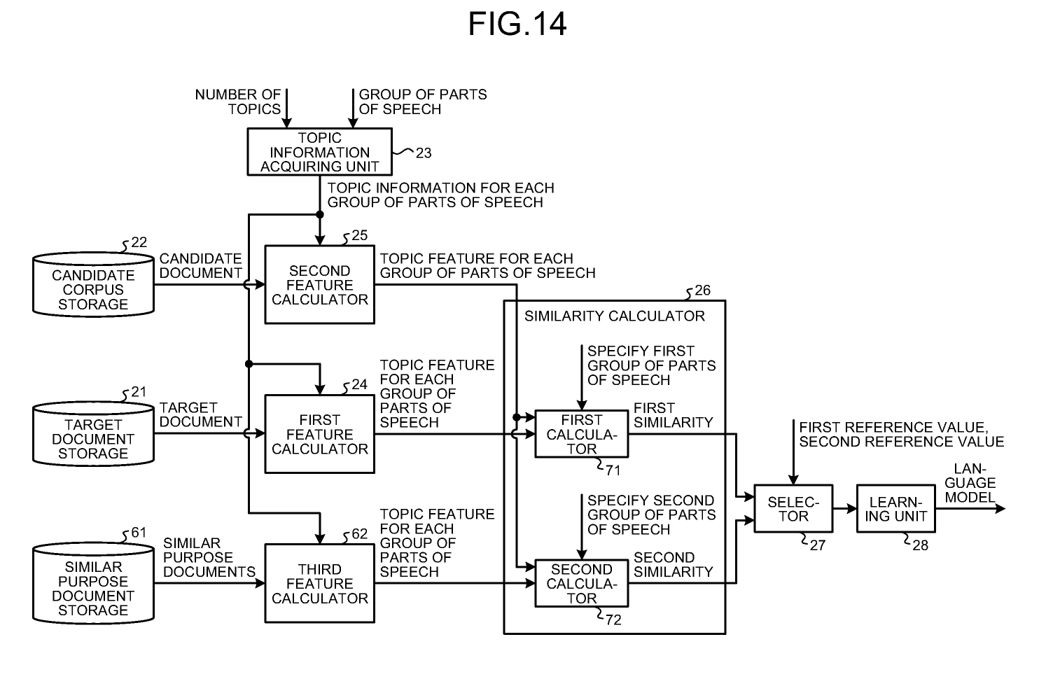

FIG. 14 is a diagram illustrating a configuration of the information processing device 10 according to the second embodiment. The information processing device 10 according to the second modified example further includes a similar purpose document storage 61 and a third feature calculator 62.

The similar purpose document storage 61 stores documents (similar purpose documents) for learning a language model used for a purpose similar to that of a language model to be learned. When the language model to be learned is to be used for speech recognition at a call center of a digital home electric appliance manufacturer, for example, a language model to be learned by using a similar purpose document is to be used for speech recognition at a call center of a manufacturer of other products.

The topic information acquiring unit 23 acquires topic information in which contained words are classified into part-of-speech groups. The topic information acquiring unit 23 generates topic information containing nouns (first part-of-speech group) and topic information containing words other than nouns (second part-of-speech group including particles, auxiliary verbs, verbs, and pronouns, for example), for example.

The first feature calculator 24 calculates a topic feature for each part-of-speech group of a target document on the basis of the topic information for each part-of-speech group. The first feature calculator 24 calculates a topic feature relating to nouns (first part-of-speech group) and a topic feature relating to words other than nouns (second part-of-speech group) for the target document, for example.

The second feature calculator 25 calculates a topic feature for each part-of-speech group of each candidate document on the basis of the topic information classified into part-of-speech groups. The second feature calculator 25 calculates a topic feature relating to nouns (first part-of-speech group) and a topic feature relating to words other than nouns (second part-of-speech group) for the candidate document, for example.

The third feature calculator 62 calculates a topic feature for each part-of-speech group of a similar purpose document on the basis of the topic information classified into part-of-speech groups. The third feature calculator 62 calculates a topic feature relating to nouns (first part-of-speech group) and a topic feature relating to words other than nouns (second part-of-speech group) for the similar purpose document, for example.

The similarity calculator 26 includes a first calculator 71 and a second calculator 72. The first calculator 71 receives as input the topic features for the respective part-of-speech groups of the target document and the topic features for the respective part-of-speech groups of the respective candidate documents. The first calculator 71 also receives as input specification of the first part-of-speech group. The first calculator 71 then calculates a first similarity of each of topic features of the first part-of-speech group for the respective candidate documents to the topic feature of the first part-of-speech group for the target document. The first calculator 71 calculates the similarity (first similarity) of each of topic features of nouns (first part-of-speech group) for the respective candidate documents to the topic feature of nouns (first part-of-speech group) for the target document, for example.

The second calculator 72 receives as input the topic features for the respective part-of-speech groups of the similar purpose document and the topic features for the respective part-of-speech groups of the respective candidate documents. The second calculator 72 also receives as input specification of the second part-of-speech group. The second calculator 72 then calculates a second similarity of each of topic features of the second part-of-speech group for the respective candidate documents to the topic feature of the second part-of-speech group for the similar purpose document. The second calculator 72 calculates the similarity (second similarity) of each of topic features of parts of speech other than nouns (second part-of-speech group) for the respective candidate documents to the topic feature of parts of speech other than nouns (second part-of-speech group) for the similar purpose document, for example.

The selector 27 selects candidate documents whose first similarities are larger than a first reference value and whose second similarities are larger than a second reference value as documents to be used for learning a language model from multiple candidate documents.

Note that the first reference value and the second reference value may be values set by the user. Alternatively, the first reference value may be a value calculated on the basis of the first similarities of the candidate documents (a value based on an average value, a maximum value, or the like). The second reference value may be a value calculated on the basis of the second similarities of the candidate documents (a value based on an average value, a maximum value, or the like).

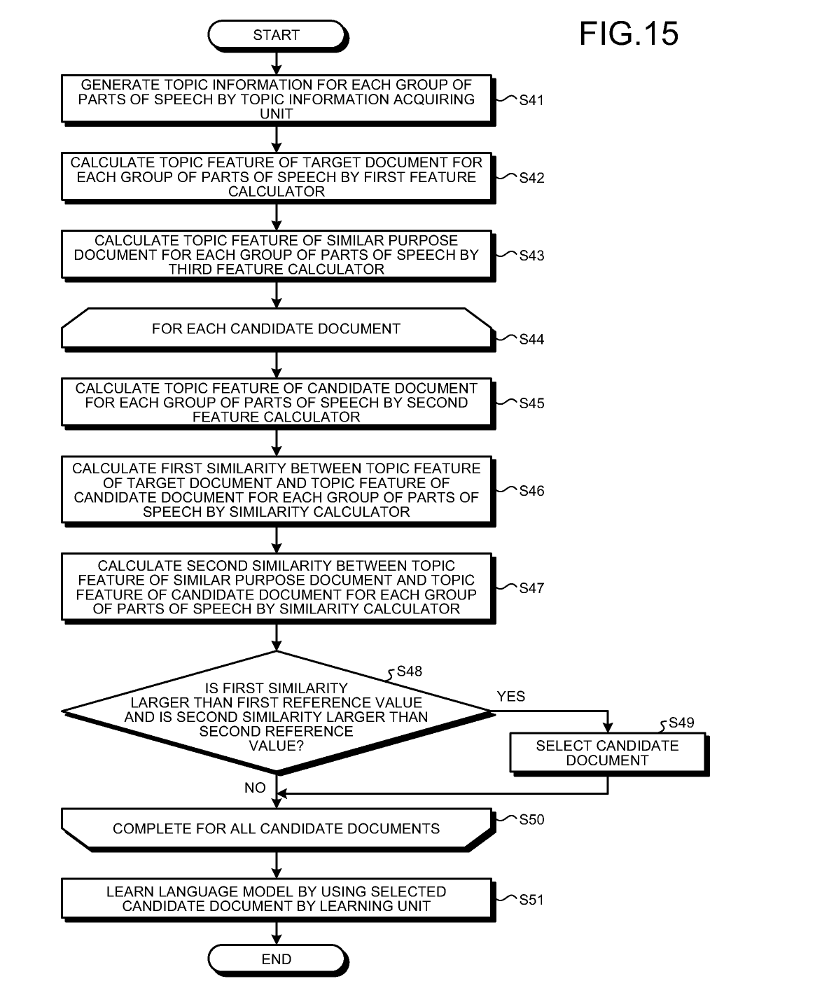

FIG. 15 is a chart illustrating a processing flow of the information processing device 10 according to the second embodiment. In the present flow, an example in which a language model to be used for speech recognition at a call center of home electric appliance manufacturer will be described.

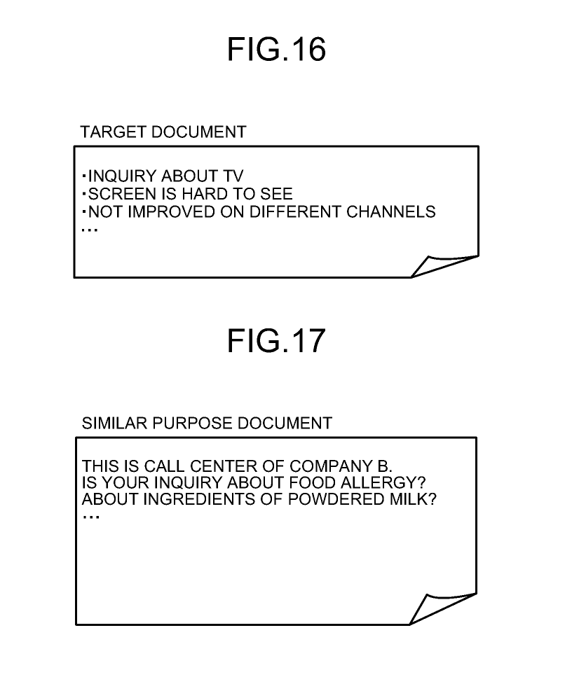

Before the processing, target documents are stored in the target document storage 21 by the user in advance. The target document storage 21 stores texts such as reports on conversations written by operators at a call center of a home electric appliance manufacturer as illustrated in FIG. 16, for example, as the target documents.

Furthermore, before the processing, the information processing device 10 acquires multiple candidate documents from the web or the like, and stores the acquired candidate documents in the candidate corpus storage 22. The candidate corpus storage 22 stores candidate documents as those illustrated in FIGS. 5, 6 and 7 similarly to the first embodiment, for example.

Furthermore, before the processing, similar purpose documents are stored in the similar purpose document storage 61 by the user in advance. The similar purpose document storage 61 stores a text as illustrated in FIG. 17 as the similar purpose document. The text in FIG. 17 is a document to be used for learning a language model used for speech recognition at a call center of a manufacturer of products (food) different from home electric appliances.

First, in step S41, the topic information acquiring unit 23 generates topic information for each part-of-speech group. The following Equation (11) is an equation expressing an example of a set of part-of-speech groups in the present embodiment.

PoS=(A,B)=([Nouns],[Particles,Auxiliary verbs,Verbs,Pronouns]) (11)

The equation of Equation (11) indicates that the first group A of parts of speech includes nouns and that the second group B of parts of speech includes particles, auxiliary verbs, verbs, and pronouns. Alternatively, the topic information acquiring unit 23 may generate topic information classified into three or more part-of-speech groups.

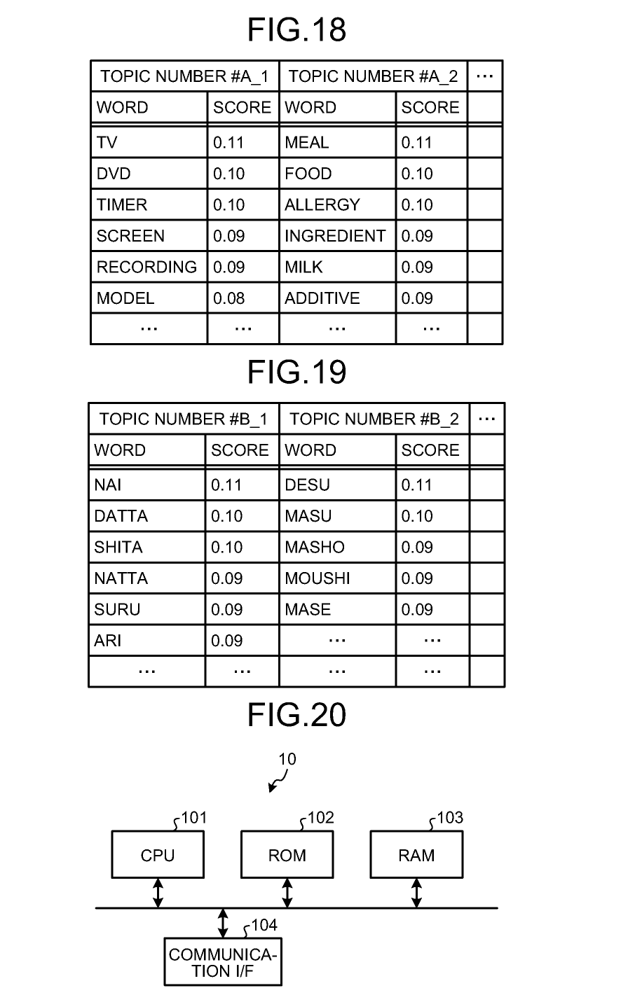

The topic information acquiring unit 23 generates topic information as illustrated in FIG. 18 as the topic information of the first group A of parts of speech, for example. The topic information acquiring unit 23 also generates topic information as illustrated in FIG. 19 as the topic information of the second group B of parts of speech, for example.

Since the topic information is generated for each part-of-speech group in this manner, words that are nouns can be classified into topics such as “digital home electric appliances” (topic number #A_1) and “food” (topic number #A_2) in the topic information of nouns, for example. Furthermore, words can be classified into sentence or speech styles such as a “style used in writing” (topic number #B_1) and a “polite speech style” (topic number #B_2) in the topic information of particles, auxiliary verbs, verbs, and pronouns. Note that the number of topics in the first part-of-speech group may be different from that in the second part-of-speech group.

Subsequently, in step S42, the first feature calculator 24 calculates a topic feature for each part-of-speech group of the target document on the basis of the topic information for each part-of-speech group. The following Equations (12) express the topic feature of the first group A of parts of speech for the target document and the topic feature of the second group B of parts of speech for the target document.

\vec{T}_{A}(t)=(T_{A1},T_{A2}, . . . )=(0.74,0.03, . . . )

\vec{T}_{B}(t)=(T_{B1},T_{B2}, . . . )=(0.81,0.09, . . . ) (12)

Since the values of the topic number #A_1 and the topic number #B_1 are large as expressed by Equations (12), the target document is found to be highly relevant to the “digital home electric appliances” and the “style used in writing.”

Subsequently, in step S43, the third feature calculator 62 calculates a topic feature for each part-of-speech group of the similar purpose document on the basis of the topic information for each part-of-speech group. The following Equations (13) express the topic feature of the first group A of parts of speech for the similar purpose document and the topic feature of the second group B of parts of speech for the similar purpose document.

\vec{T}_{A}(t′)=(0.01,0.85, . . . )

\vec{T}_{B}(t′)=(0.10,0.80, . . . ) (13)

Since the values of the topic number #A_2 and the topic number #B_2 are large as expressed by Equations (13), the similar purpose document is found to be highly relevant to the “food” and the “polite speech style.”

Subsequently, the information processing device 10 repeats processing from step S45 to step S49 for each candidate document stored in the candidate corpus storage 22 (loop processing between step S44 and step S50).

In the loop processing for each candidate document, first in step S45, the second feature calculator 25 calculates a topic feature for each part-of-speech group of the candidate document. The following Equations (14) express the topic features of the first group A of parts of speech and the second group B of parts of speech for the candidate document C_{n1}, the candidate document C_{n2}, and the candidate document C_{n3}.

$$\{ \begin{matrix}{\vec{T}}_{A} ( {c}_{n 1} ) = ( 0.79 , 0.01 , … ) \\ {\vec{T}}_{B} ( {c}_{n 1} ) = ( 0.10 , 0.80 , … )\end{matrix} \\ \{ \begin{matrix}{\vec{T}}_{A} ( {c}_{n 2} ) = ( 0.76 , 0.06 , … ) \\ {\vec{T}}_{B} ( {c}_{n 2} ) = ( 0.75 , 0.10 , … )\end{matrix} \\ \{ \begin{matrix}{\vec{T}}_{A} ( {c}_{n 3} ) = ( 0.03 , 0.84 , … ) \\ {\vec{T}}_{B} ( {c}_{n 3} ) = ( 0.06 , 0.79 , … )\end{matrix} \qquad ( 14 )$$

Since the values of the topic number #A_1 and the topic number #B_2 are large as expressed by Equations (14), the candidate document C_{n1} is found to be highly relevant to the “digital home electric appliances” and the “polite speech style.” Since the values of the topic number #A_1 and the topic number #B_1 are large in, the candidate document C_{n2} is found to be highly relevant to the “digital home electric appliances” and the “style used in writing.” Since the values of the topic number #A_2 and the topic number #B_2 are large, the candidate document C_{n3} is found to be highly relevant to the “food” and the “polite speech style.”

Subsequently, in step S46, the first calculator 71 of the similarity calculator 26 calculates the similarity (first similarity) between the topic feature of the target document and the topic feature of the candidate document for each part-of-speech group. In the present embodiment, the first calculator 71 calculates the inner product of the topic feature of the target document and the topic feature of the candidate document for each of the first group A of parts of speech and the second group B of parts of speech as expressed by the following Equations (15).

sim_{A}(t,cⱼ)=\vec{T}_{A}(t)·\vec{T}_{A}(cⱼ)

sim_{B}(t,cⱼ)=\vec{T}_{B}(t)·\vec{T}_{B}(cⱼ) (15)

Subsequently, in step S47, the second calculator 72 of the similarity calculator 26 calculates the similarity (second similarity) between the topic feature of the similar purpose document and the topic feature of the candidate document for each part-of-speech group. In the present embodiment, the first calculator 71 calculates the inner product of the topic feature of the similar purpose document and the topic feature of the candidate document for each of the first group A of parts of speech and the second group B of parts of speech as expressed by the following Equations (16).

sim_{A}(t′,cⱼ)=\vec{T}_{A}(t′)·\vec{T}_{A}(cⱼ)

sim_{B}(t′,cⱼ)=\vec{T}_{B}(t′)·\vec{T}_{B}(cⱼ) (16)

Subsequently, in step S48, the selector 27 determines whether or not the first similarity is larger than the first reference value (th_{A}) and the second similarity is larger than the second reference value (th_{B}). The following Inequalities (17) is an expression of a condition for the determination by the selector 27.

sim_{A}(t,cₙ)>th_{A} and sim_{B}(t′,cₙ)>th_{B} (17)

If the condition is not satisfied (No in step S48), the selector 27 moves the processing to step S50. If the condition is satisfied (Yes in step S48), the selector 27 moves the processing to step S49.

In step S49, the selector 27 selects the corresponding candidate document as the document to be used for learning the language model. In the present example, the first reference value and the second reference value are set to 0.50, and the selector 27 selects the candidate document C_{n1} whose first similarity and second similarity are both larger than 0.50. The selector 27 then moves the processing to step S50.

In step S50, if the processing from step S45 to step S49 has not yet been completed for all the candidate documents, the selector 27 returns the processing to step S44 and repeats the processing for the next candidate document. If the processing is completed, the selector 27 moves the processing to step S51.

In step S51, the learning unit 28 learns the language model using the selected candidate document. After completing the processing in step S51, the information processing device 10 then terminates the present flow.

Note that the conditional expressions of Inequalities (17) for the candidate document C_{n1} are as follows in the second embodiment:

sim_{—}A(t,C_{—}{n1})=0.74*0.79+0.11*0.03=0.59, and

sim_{—}B(t′,C_{—}{n1})=0.10*0.10+0.8*0.8=0.65.

Thus, since the candidate document C_{n1} satisfies the condition with both of the first group A of parts of speech and the second group B of parts of speech, the candidate document C_{n1} is extracted as a document for learning. The candidate document C_{n1} is a document on a digital home electric appliance in a polite speech style, and matches speech uttered at the call center. The information processing device 10 can therefore generate a language model with high performance through learning using such documents.

If the similarity to the target document is used for both of the first part-of-speech group and the second part-of-speech group, the conditional expressions of Inequalities (17) for the second group B of parts of speech of the candidate document C_{n1} will be sim_B(t, C_{n1})=0.15. In this case, the candidate document C_{n1} will not satisfy the condition and will not be selected as a document for learning. In contrast, the conditional expressions of Inequalities (17) for the candidate document C_{n2} will be sim_A(t, C_{n2})=0.56, sim_B(t, C_{n2})=0.65. In this case, the candidate document C_{n2} will be selected as a document for learning, which means that a document containing words in a style used in writing that are not actually uttered at the call center will be selected as a document for learning.

If the similarity to the similar purpose document is used for both of the first part-of-speech group and the second part-of-speech group, the conditional expressions of Inequalities (17) for the first group A of parts of speech of the candidate document C_{n1} will be sim_A(t, C_{n1})=0.11. In this case, the candidate document C_{n1} will not satisfy the condition and will not be selected as a document for learning.

In contrast, the conditional expressions of Inequalities (17) for the candidate document C_{n3} will be sim_A(t, C_{n3})=0.71, sim_B(t, C_{n3})=0.64. In this case, the candidate document C_{n3} will be selected as a document for learning, which means that a document similar to speech at a call center of a different topic will be selected as a document for learning.

With the information processing device 10 according to the second embodiment as described above, when a major theme of a target document and a speech style of a similar purpose document are known in advance, a document for learning suitable for the purpose can be selected by using combination of features of the target document and the similar purpose document.

Hardware Configuration

FIG. 20 is a diagram illustrating an example of a hardware configuration of the information processing device 10 according to the embodiments. The information processing device 10 according to the embodiments includes a controller such as a central processing unit (CPU) 101, a storage such as a read only memory (ROM) 102 and a random access memory (RAM) 103, a communication interface (I/F) 104 for connecting to a network for communication, and a bus that connects these components.

Programs to be executed by the information processing device 10 according to the embodiments are embedded on the ROM 102 or the like in advance and provided therefrom. The programs to be executed by the information processing device 10 according to the embodiments may alternatively be recorded on a computer readable recording medium such as a compact disk read only memory (CD-ROM), a flexible disk (FD), a compact disk recordable (CD-R), and a digital versatile disk (DVD) in a form of a file that can be installed or executed, and provided as a computer program product.

Alternatively, the programs to be executed by the information processing device 10 according to the embodiments may be stored on a computer system connected to a network such as the Internet, and provided by being downloaded by the information processing device 10 via the network. Still alternatively, the programs to be executed by the information processing device 10 according to the embodiments may be provided or distributed through a network such as the Internet.

The programs to be executed by the information processing device 10 according to the embodiments include a topic information acquisition module, a first feature calculation module, a second feature calculation module, a third feature calculation module, a similarity calculation module, a selection module, and a learning module, and can cause a computer to function as the respective components (the topic information acquiring unit 23, the first feature calculator 24, the second feature calculator 25, the similarity calculator 26, the third feature calculator 62, the selector 27, and the learning unit 28) of the information processing device 10 described above. In the computer, the CPU 101 can read out the programs from a computer-readable storage medium onto a main storage and execute the programs. Note that some or all of the topic information acquiring unit 23, the first feature calculator 24, the second feature calculator 25, the similarity calculator 26, the third feature calculator 62, the selector 27, and the learning unit 28 may be implemented by hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a first feature calculator configured to calculate a topic feature representing a strength of relevance of document of at least one topic to a target document that matches a purpose for which a language model is to be used;
a second feature calculator configured to calculate the topic feature for each of a plurality of candidate documents;
a similarity calculator configured to calculate a similarity of each of the topic features of the candidate documents to the topic feature of the target document; and
a selector configured to select, as a document to be used for learning the language model, a candidate document whose similarity is larger than a reference value from among the candidate documents.

2. The device according to claim 1, further comprising a topic information acquiring unit configured to acquire topic information containing sets of pairs of words and scores for each topic, the scores each representing a strength of relevance of the associated word to the each topic, wherein
the first feature calculator and the second feature calculator are configure to calculate the topic features on the basis of the topic information.

3. The device according to claim 2, wherein the first feature calculator and the second feature calculator are configured to calculate the topic features by accumulating the scores of the words contained in the document to be processed for each topic.

4. The device according to claim 1, further comprising a learning unit configured to learn the language model on the basis of the selected candidate document.

5. The device according to claim 2, wherein the topic information acquiring unit is configured to generate the topic information by using the candidate documents.

6. The device according to claim 5, wherein the topic information acquiring unit is configured to generate a plurality of pieces of topic information each containing a different number of topics, calculate a plurality of topic features for the target document on the basis of the generated pieces of topic information, and select a piece of topic information from the generated pieces of topic information on the basis of the calculated topic features.

7. The information processing device according to claim 5, wherein
the topic information acquiring unit is configured to generate the topic information for each part-of-speech group, and
the first feature calculator and the second feature calculator are configured to calculate the topic features for each part-of-speech group on the basis of the topic information for each part-of-speech group.

8. The device according to claim 7, further comprising a third feature calculator configured to calculate the topic features for each part-of-speech group for a similar purpose document, the similar purpose document being different in content from the target document, being a reference for learning the language model, and being for learning a language model used for a purpose similar to that of the language model to be learned, wherein
the similarity calculator is configured to calculate a first similarity of the topic feature of the target document for a first part-of-speech group to the topic feature of each of the candidate documents for the first part-of-speech group, and calculate a second similarity of the topic feature of the similar purpose document for a second part-of-speech group to the topic feature of each of the candidate documents for the second part-of-speech group, and
the selector is configured to select a candidate document whose first similarity is larger than a first reference value and whose second similarity is larger than a second reference value as a document to be used for learning the language model.

9. An information processing method comprising:
calculating a topic feature representing a strength of relevance of document of at least one topic to a target document that matches a purpose for which a language model is to be used;
calculating the topic feature for each of a plurality of candidate documents;
calculating a similarity of each of the topic features of the candidate documents to the topic feature of the target document; and
selecting as a document to be used for learning the language model a candidate document whose similarity is larger than a reference value from among the candidate documents.

10. A computer program product comprising a computer-readable medium containing a program executed by a computer, the program causing the computer to execute:
calculating a topic feature representing a strength of relevance of document of at least one topic to a target document that matches a purpose for which a language model is to be used;
calculating the topic feature for each of a plurality of candidate documents;
calculating a similarity of each of the topic features of the candidate documents to the topic feature of the target document; and
selecting as a document to be used for learning the language model a candidate document whose similarity is larger than a reference value from among the candidate documents.
